(19) United States
(12) Patent Application Publication
(10) Pub. No.: US 2020/0089537 A1
(43) Pub. Date: Mar. 19, 2020

(54) APPARATUS AND METHOD FOR BANDWIDTH ALLOCATION AND QUALITY OF SERVICE MANAGEMENT IN A STORAGE DEVICE SHARED BY MULTIPLE TENANTS

(71) Applicant: Intel Corporation, Santa Clara, CA (US)

(72) Inventors: Shirish BAHIRAT, Longmont, CO (US); David B. CARLTON, Oakland, CA (US); Jackson ELLIS, Fort Collins, CO (US); Jonathan M. HUGHES, Longmont, CO (US); David J. PELSTER, Longmont, CO (US); Neelesh VEMULA, Sunnyvale, CA (US)

(21) Appl. No.: 16/689,895

(22) Filed: Nov. 20, 2019

(51) Int. Cl. G06F 9/50; G06F 9/52; G06F 9/46; G06F 9/54; G06F 9/48; G06F 3/06

(52) U.S. Cl. CPC G06F 9/5011; G06F 9/524; G06F 9/468; G06F 9/546; G06F 3/0614; G06F 3/0659; G06F 3/0679; G06F 3/0631; G06F 9/4881

(57) ABSTRACT

A solid-state drive that can service multiple users or tenants and workloads (that is, multiple tenants) by enabling assigned bandwidth share of the solid-state drive across tenants is provided. The assigned bandwidth share is enabled for command submissions within a same assigned domain in addition to a weighted bandwidth share and quality of service control across different domains from all tenants.

### FIELD

This disclosure relates to a solid-state drive and in particular to bandwidth allocation and quality of service for a plurality of tenants that share bandwidth of the solid-state drive.

### BACKGROUND

Cloud computing provides access to servers, storage, databases, and a broad set of application services over the Internet. A cloud service provider offers cloud services such as network services and business applications that are hosted in servers in one or more data centers that can be accessed by companies or individuals over the Internet. Hyperscale cloud-service providers typically have hundreds of thousands of servers. Each server in a hyperscale cloud includes storage devices to store user data, for example, user data for business intelligence, data mining, analytics, social media and micro-services. The cloud service provider generates revenue from companies and individuals (also referred to as tenants) that use the cloud services.

### BRIEF DESCRIPTION OF THE DRAWINGS

Features of embodiments of the claimed subject matter will become apparent as the following detailed description proceeds, and upon reference to the drawings, in which like numerals depict like parts, and in which:

FIG. 1 is a block diagram of a solid-state drive shared by a plurality of tenants that provides per tenant Bandwidth (BW) allocation and Quality of Service (QoS);

FIG. 2 is a block diagram of the solid-state drive shown in FIG. 1;

FIG. 3 is a block diagram of a single die view of the solid-state drive command queues shown in FIG. 2;

FIG. 4 is a block diagram of an all die view including the solid-state drive command queues 214 shown in FIG. 2.

FIG. 5 is a block diagram of an embodiment of a command scheduler in the a bandwidth allocation and quality of service controller shown in FIG. 1;

FIG. 6A and FIG. 6B are tables illustrating bandwidth assignment to tenant groups and quality of service requirements for tenant groups in a solid-state drive;

FIG. 7 is a flowgraph illustrating a method implemented in the solid-state drive shared by a plurality of tenants shown in FIG. 1 to provide per user Bandwidth (BW) allocation and Quality of Service (QoS) using Adaptive Credit Based Weighted Fair Scheduling; and

FIG. 8 is a block diagram of an embodiment of a computer system that includes bandwidth allocation and Quality of Service management in a storage device shared by multiple tenants.

Although the following Detailed Description will proceed with reference being made to illustrative embodiments of the claimed subject matter, many alternatives, modifications, and variations thereof will be apparent to those skilled in the art. Accordingly, it is intended that the claimed subject matter be viewed broadly, and be defined as set forth in the accompanying claims.

### DESCRIPTION OF EMBODIMENTS

The remuneration paid to the cloud service provider may also be based on per user bandwidth allocation, Input/Outputs Per Second (IOPs) and Quality of Service (QoS). However, as the capacity of storage devices such as solid-state drives (SSDs) increases, one solid-state drive in the server may be shared by multiple users (that can also be referred to as tenants).

The remuneration paid by a tenant may be dependent on resources such as storage capacity, bandwidth allocation and quality of service for the solid-state drive for the tenant. In addition, cloud service providers may charge based on usage of storage and thus require dynamic configuration and smart utilization of resources with fine granularity.

Non-Volatile Memory Express (NVMe) Sets, Open Channel SSD's, Input Output (IO) determinism are techniques that can be used to manage Quality of Service for solid-state drives, for example by not performing garbage collection in deterministic mode, providing data isolation through NVMe sets by accessing independent channels and media. These techniques require major changes in a host software stack. However, these techniques do not allow direct configuration control over quality of service and bandwidth allocations in a solid-state drive. As, in many cases the application requirements for solid-state drives changes dynamically and drastically, these techniques do not allow dynamic configuration and utilization of resources with fine granularity. Also, some users that have a smaller capacity than other users can thrust commands with impeccable rates thus blocking other users getting a fair share of quality of service and bandwidth of the solid-state drive. In addition, if a user is reserving high bandwidth and quality of service but is not utilizing the reserved high bandwidth and quality of service to full extent, Non-Volatile Memory Express (NVMe) Sets, Open Channel SSD's, and Input Output (IO) determinism do not distribute unused or spare bandwidth of the solid-state drive to other users in fair manner.

In an embodiment, a solid-state drive can service multiple users or tenants and workloads (that is, multiple tenants) by enabling assigned bandwidth share of the solid-state drive across users (tenants) for command submissions within a same assigned group in addition to a weighted bandwidth share and quality of service control across different command groups from all users (tenants).

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

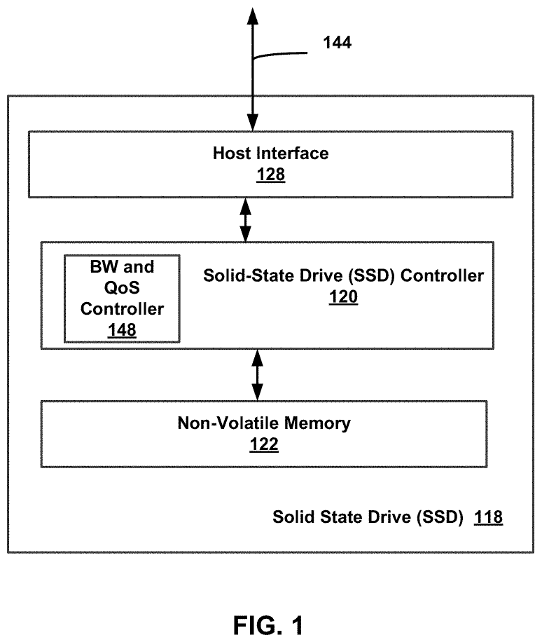

FIG. 1 is a block diagram of a solid-state drive 118 shared by a plurality of users that provides per tenant Bandwidth (BW) allocation and Quality of Service (QoS).

The capacity solid-state drive (“SSD”) 118 includes a solid-state drive controller 120, a host interface 128 and non-volatile memory 122 that includes one or more non-volatile memory devices. The solid-state drive controller 120 includes a bandwidth allocation and quality of service controller 148. In an embodiment, the solid-state drive 118 is communicatively coupled over bus 144 to a host (not shown) using the NVMe (NVM express) protocol over PCIe (Peripheral Component Interconnect Express) or Fabric. Commands (for example, read, write (“program”), erase commands for the non-volatile memory 122) received from the host over bus 144 are queued and processed by the solid-state drive controller 120.

A domain is a group of users that require similar bandwidth and Quality of Service. A command domain is a group of submission queues that share the same command type e.g., read, write. The bandwidth allocation and quality of service controller 148 provides equal bandwidth share of the solid-state drive 118 across users (tenants) for command submissions within a same assigned domain in addition to a weighted bandwidth share and quality of service control across different command groups from all users (tenants).

Operations to be performed for a group of users that require similar bandwidth and Quality of Service can be separated into command domains and can also be based on priority (for example, high, mid, low priority) of the operations.

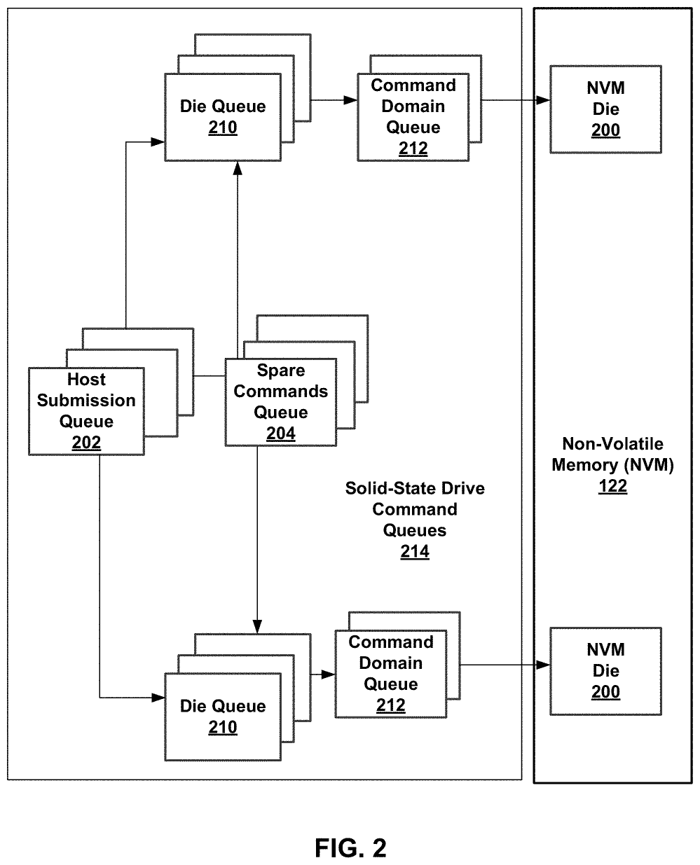

FIG. 2 is a block diagram of the solid-state drive 118 shown in FIG. 1. As discussed in conjunction with FIG. 1, the solid-state drive 118 includes non-volatile memory 122. In an embodiment, the non-volatile memory 122 includes a plurality of non-volatile memory (NVM) dies 200. A solid-state drive can have a large number of non-volatile memory dies 200 (for example, 256 NAND dies) with each non-volatile memory die 200 operating on one command at a time.

To ensure that each user obtains a weighted fair share of the bandwidth of the solid-state drive 118, a host coupled to the solid-state drive 118 can assign a percentage of the total bandwidth to each domain and can communicate the bandwidth allocation per domain via management commands, dataset management, set directives or through the Non-Volatile Memory express (NVMe) Set feature command.

The solid-state drive controller 120 shown in FIG. 1 includes solid-state drive command queues 214 that are shown in FIG. 2. The solid-state drive command queues 214 are used by the bandwidth allocation and quality of service controller 148 shown in FIG. 1. The solid-state drive controller 120 can initiate a command to read data stored in non-volatile memory dies 200 and write data (“write” may also be referred to as “program”) to non-volatile memory dies 200 in response to a request from a tenant (user) received over bus 144 from a host. The solid-state drive command queues 214 store the received commands for the non-volatile memory 122.

The solid-state drive command queues 214 include host submission queues 202 and a spare commands queue 204 per host submission queue 202. The spare commands queue 204 stores commands for which resources have not yet been allocated. If a command is received for one of the die queues 210 that is full, the command is temporarily stored in the spare commands queue 204.

The solid-state drive command queues 214 also include die queues 210 and command domain queues 212 per non-volatile memory die 200. Each die queue 210 stores commands for which resources have been allocated for one of a plurality of command types for one of a plurality of users of the solid-state drive 118. Each command domain queue 212 stores commands with one of the plurality of command types for the plurality of users of the solid-state drive 118 for which resources have been allocated. Each host submission queue 202 stores commands to be sent to one of the non-volatile memory dies 200 in the solid-state drive 118. The commands in the host submission queues 202 can be directed to any of the plurality of non-volatile memory dies 200 in the solid-state drive 118 via the die queues 210.

Commands that are received over bus 144 by the host interface 128 in the solid-state drive 118 are stored in the host submission queues 202 based on type of command and the domain associated with the command. A domain comprises one or more users of the solid-state drive 118 that require similar bandwidth and quality of service. In an embodiment there are 256 host submission queues 202 and each of the host submission queues 202 is mapped to one domain.

In an embodiment, there is one set of 256 die queues 210 per non-volatile memory die 200. The die queues 210 allow a one-to-one mapping from the host submission queues 202 to each non-volatile memory die 200. In an embodiment, the depth (total number of entries stored per die queue 210) of each die queue 210 is 32.

There is one command domain queue 212 per domain per non-volatile memory die 200. In an embodiment, there can be five domains and the depth (total number of entries stored per command domain queue 212) of each domain queue is 2.

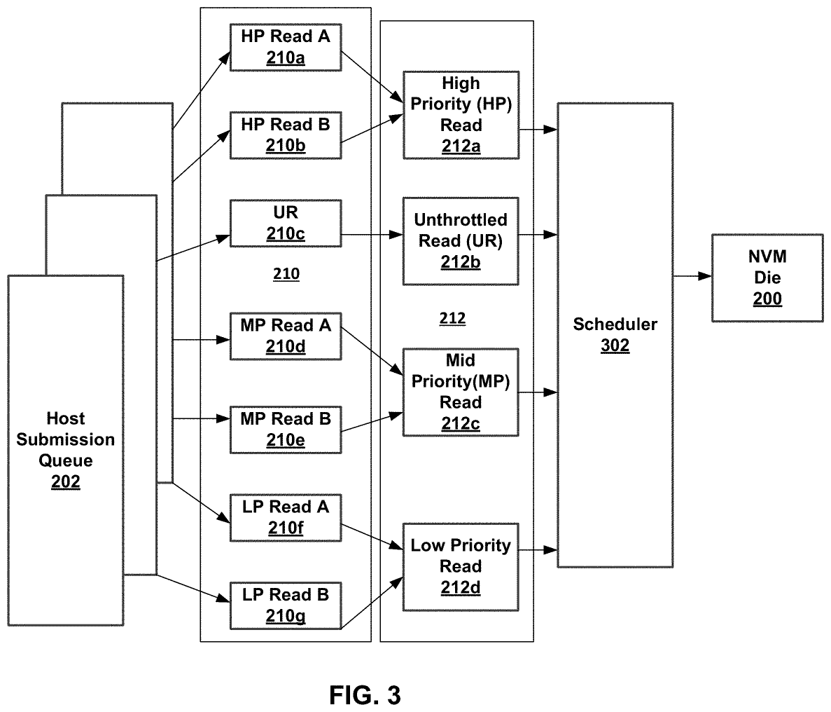

FIG. 3 is a block diagram of a single die view of the solid-state drive command queues 214 shown in FIG. 2. Each of the plurality of host submission queues 202 is allocated to a user and also associated with the domain in which the user is a member. In the example shown in FIG. 3, 3 of the 256 host submission queues 202 are shown. Each host submission queue 202 is assigned to store only one type of operation (for example, a read or a write operation) for the user. In an embodiment, the host submission queues 202 are implemented as First-In-First-Out (FIFO) circular queues.

Commands from the host submission queues 202 are moved to the die queues 210 using a round robin per domain fetch. In the example in FIG. 3, seven of the 256 per die queues 210a-g and four command domain queues 212a-d are shown. Each die queue 210a-g has a depth of 32 commands and each command domain queue 212a-d has a depth of 2 commands.

Per die queues 210a-d can store throttled or non-throttled commands. In the embodiment shown, per die queues 210a-b and 210d store throttled read commands and per die queue 210c stores unthrottled read commands. Commands received by the solid-state drive 118 from the host communicatively coupled to the solid-state drive 118 can be throttled or unthrottled commands.

The host controls incoming command arrival rates to the solid-state drive 118 for throttled commands. If commands are accumulating in the host submission queues 202, the host throttles the command submission rate and enqueues commands with additional latency to allow the solid-state drive 118 to catch up. The command service rate and arrival rate is maintained in conjunction with the command submission rate. The throttling of the command submission rate is synonymous to a closed loop feedback control system.

The host enqueues an unthrottled command in host submission queues 202 in the solid-state drive 118 as an application executing in the host issues a request to the solid-state drive 118. From the host standpoint there is no control over incoming command and service rates to the solid-state drive 118. This can result in the accumulation of a large number of commands in submission queues. The solid-state drive 118 manages the service rate based on the arrival rate. There is no control by the host over the command submission rate.

Per die queue 210a can store up to 32 high priority read commands for User A and per die queue 210b can store up to 32 high priority read commands for User B. The high priority read commands for User A and User B are forwarded to the high priority read command domain queue 212a.

Per die queue 210c can store up to 32 unthrottled read commands. The unthrottled read commands are forwarded to the unthrottled read command queue 212b.

Per die queue 210d can store up to 32 low priority read commands for User A and per die queue 210e can store up to 32 low priority read commands for User B. The low priority read commands for User A and User B are forwarded to the low priority read command domain queue 212c.

Per die queue 210f can store up to 32 mid priority read commands for User A and per die queue 210g can store up to 32 mid priority read commands for User B. The mid priority read commands for User A and User B are forwarded to the mid priority read command domain queue 212d.

The scheduler 302 selects the next command from one of the command domain queues 212a-d to be sent to the die to provide equal bandwidth share of the solid-state drive across users for command submissions within a same assigned domain in addition to a weighted bandwidth share and quality of service control across different command groups from all users.

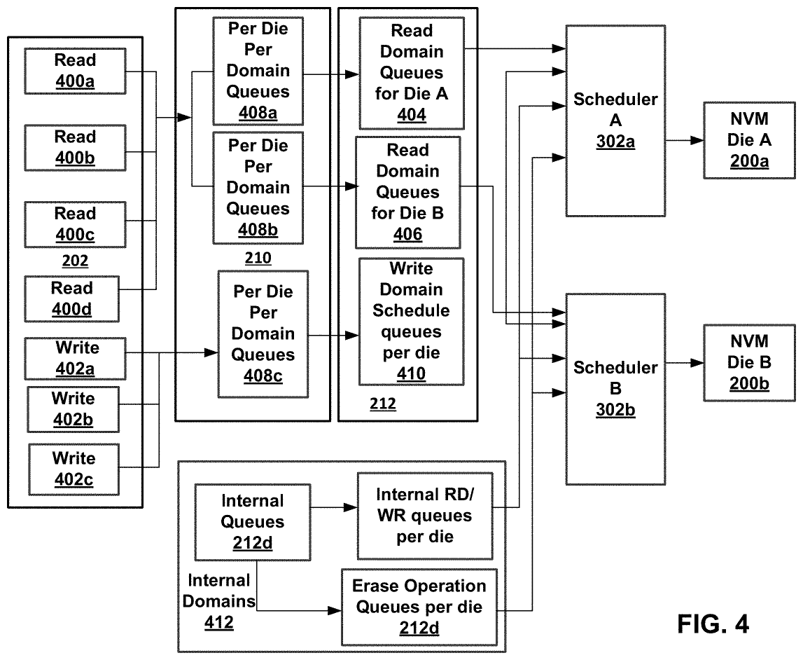

FIG. 4 is a block diagram of an all die view including the solid-state drive command queues 214 shown in FIG. 2. In the example shown, there are four read commands 400a-d and three write commands 402a-c in the host submission queues 202 and two non-volatile memory dies 200a-b. Read commands 400a-d for the non-volatile memory dies 200a-b are tagged based on user, priority and throttle rate. Write commands 402a-c for the non-volatile memory dies 200a-b are also tagged based on user, priority and throttle rate.

Read commands 400a-d and write commands 402a-c in the host submission queue 202 are moved to one of the plurality of die queues 210 based on command types included in the read or write command and user requirements. For example, an address included in the read or write command can be used to search a flash translation lookup table to determine the non-volatile memory die 200 to which the command is to be sent.

In the example shown in FIG. 4, read commands 400a-d for die A 200a are first queued in per die per domain queues 408a for die A 200a and then in read domain queues for Die A 404 prior to being scheduled by scheduler A 302a. Read commands 400a-d for die B 200b are first queued in per die per domain queues 408b for die B 200b and then in read domain queues for Die B 406 prior to being scheduled by scheduler B 302b. Write commands 402a-c for die A 200a and die B 200b are first queued in per die per domain queues 408c and then queued in write domain schedule queues per die 410 prior to being scheduled by scheduler A 302a or scheduler B 302b based on whether the write command is for die A 200a or die B 200b.

In addition to scheduling write and read commands received from the host, commands generated internally in the solid-state drive 118 can be scheduled through the use of internal domains 412. The internal domains 412 includes per namespace defragmentation and internal operation queues 414 and a read per die queue and a write per die queue for internally generated read and write commands and a per die erase operation queue 418. The internally generated read and write commands the erase operation commands are directed to the respective die scheduler 302a, 302b based on whether the command is for die A 200a or die B 200b.

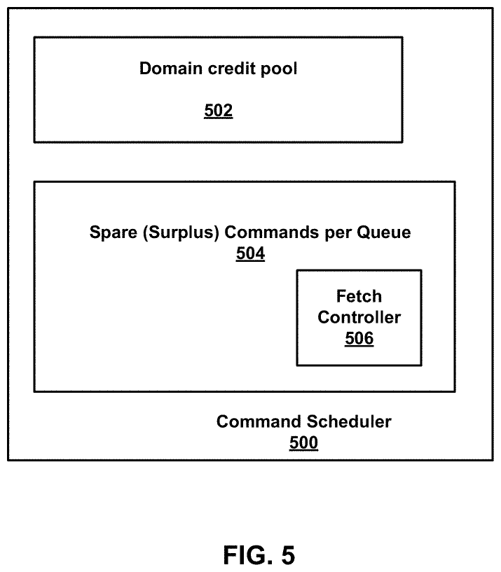

FIG. 5 is embodiment of a command scheduler 500 in the bandwidth allocation and quality of service controller 148 shown in FIG. 1. The command scheduler 500 includes a domain credit pool 502 and an adaptive credit based weighted fair queuing manager 504. The command scheduler 500 uses the solid-state drive command queues 214 described in conjunction with FIG. 2 in addition to the domain credit pool 502 and the adaptive credit based weighted fair queuing manager 504 to provide equal bandwidth share of the solid-state drive 118 across users for command submissions within a same assigned domain in addition to a weighted bandwidth share and quality of service control across different command groups from all users.

The adaptive credit based weighted fair queuing manager 504 can include a Fetch Controller 506 (which may also be referred to as a Domains Synchronization Mechanism) to map commands in the host submission queues 202 to the die submission queues 201 based on command types and user requirements. For example, an address included in a command can be used to search a flash translation lookup table to determine the non-volatile memory die 200 to which the command is to be sent.

The adaptive credit based weighted fair queuing manager 316 in the command scheduler 500 schedules commands using per die adaptive credit based weighted fair sharing amongst all of the domains that share the solid-state drive 118. The command scheduler 500 tracks all commands per domain that are assigned to all non-volatile memory dies 200 in the solid-state drive 118 and uses the domain credit pool 502 to limit over-fetching by one domain

If the maximum number of commands for a domain across all non-volatile memory dies 200 in the solid-state drive 118 would be exceeded, the next command for the domain is delayed until the number of in process commands for the domain decreases. This prevents one domain from over utilizing command resources and also reduces time to manage prioritization of commands for domains.

The domain credit pool 502 is shared by all domains. Initially each domain is assigned equal credit. The command scheduler 500 synchronizes the fetch of a command from the host submission queue 202 based on a credit mechanism to avoid over fetching.

When a domain sends a command to a non-volatile memory die 200, the credit is subtracted from the credit balance for the domain in the domain credit pool 310. During the selection process, the command scheduler 500 assigns the command to the domain that has the greatest credit. After this decision is made, resource binding is completed using late resource binding if any of the domains runs out of credits, the same credit is assigned to all domains. If unused credits exceed a threshold for a specific domain, credits are set to maximum predefined limits. Depending on bandwidth requirement each domain has a base credit for each command and depending on quality of service requirement each domain adapts to per command credit.

To ensure that each user obtains a fair share of quality of service and bandwidth of the solid-state drive 118, late resource binding is used, that is, resources are not allocated to a command until the command is ready to be scheduled. The command scheduler 500 uses late resource binding to assign resources to commands that are ready to be scheduled to avoid resource deadlock. As commands from the host are received by the solid-state drive, the command scheduler 500 prioritizes commands using adaptive credit based weighted fair queuing by allocating internal solid-state drive resources such as buffers and descriptors to commands that can be scheduled. Commands that are not ready to be scheduled are not allocated any resources.

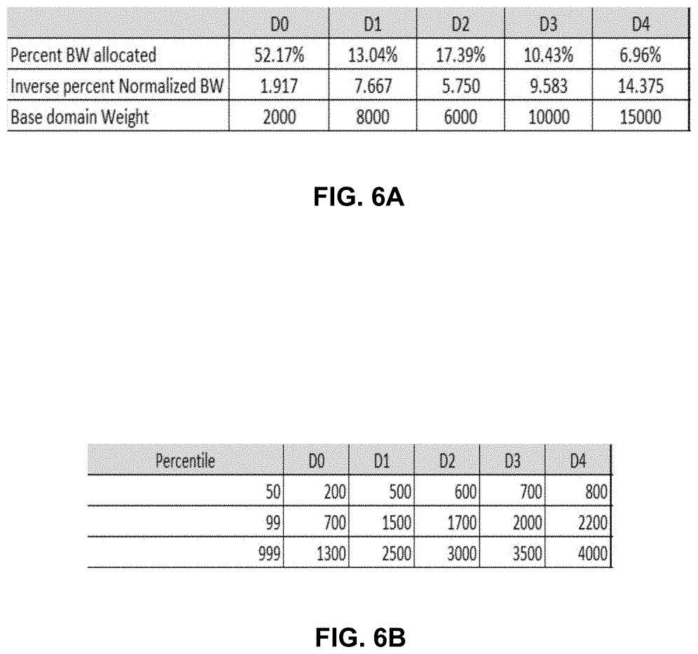

FIG. 6A and FIG. 6B are tables illustrating bandwidth assignment to domains and quality of service requirements for domains in the solid-state drive 118.

Referring to FIG. 6A, in the example shown, the sum of the bandwidth allocated to five domains (D0-D4) is 100%, with 52% allocated to domain D0, 13% allocated to domain D1, 17% allocated to domain D2, 17% allocated to domain D3, 10% allocated to domain D4 and 7% allocated to domain D5. Based on the bandwidth allocation, a base domain (that can also be referred to as a group) weight is computed and assigned to each of the domains D0-D5 as shown in the third row of the table shown in FIG. 6A.

The second row of the table shown in FIG. 6A is the inverse of the allocated bandwidth shown on the first row of the table multiplied by 100. The base domain weight is computed as the inverse of the allocated bandwidth on the second row of the table multiplied by a scaler. The same scaler is used to multiply the inverse of the allocated bandwidth for each domain to achieve consistency. The scaler multiplier used to compute the base domain weight shown in the last row in the table in FIG. 6A uses about a 1000 scaler multiplier.

The base weight allocation in the example shown in FIG. 6A enables control over bandwidth but does not guarantee the quality of service because any number of commands can be pending in domain queues. Referring to FIG. 6B, a table illustrates an example of quality of service requirements in microseconds (μs) for domains (D0-D4) for 50, 99 and 99.9 percentiles. In the example shown in row 1 of FIG. 6B, 50% of commands for domain D0 are completed within 200 μs, in row 2 99% of commands for domain D0 are completed within 700 μs and in row 3, 999 of 1000 commands are completed within 1300 μs. Command completion time is dependent on the number of pending commands. The number of commands pending for each of the percentiles shown in FIG. 6B can be computed using an average time to complete a read or write command in the non-volatile memory die or using an average operation time for the non-volatile memory die. The weight for each domain (D0-D5) in the table shown in FIG. 6A is adapted based on the quality of service requirements for each domain (D0-D5) shown in FIG. 6B.

A quality of service error (Qₑ) is computed as the number of nominal expected commands (Qₙₒₘ) in the queue minus the number of current commands pending (Qₘ) in the queue as shown in equation 1 below.

Qₑ=Qₙₒₘ−Qₘ Equation 1

The quality of service error can be a positive or negative number based on the number of current commands that are pending. The quality of service error (Qe) computed using Equation 1 above is used to adjust the base domain weight (wᵢ) based on learn rate (μ), a number less than one, to provide an adjusted base domain weight (w_{i(adapted)}) as shown in equation 2 below.

w_{i(adapted)}=wᵢ+(Qₑ×μ) Equation 2

For example, to meet the 99.9 percentile target for D0, only one command in 1000 commands can exceed the quality of service requirement shown in FIG. 4B. Thus, the weight is adapted to ensure that the number of commands pending does not result in the quality of service being exceeded. To achieve the Quality of Service limits, domain weight is lowered when the number of pending command exceeds a selected limit and that particular domain needs to allocate higher priority to service commands until the pending commands are reduced.

For example, based on the example shown in the table in FIG. 6B, if domain D0 has less than 2 commands pending, command completion can be much faster than average, in this case the weight for domain D0 is increased thus slowing down the processing of domain D0 commands and the weight for domains with more commands pending can be reduced to expedite the command processing rate.

In other embodiments, the adaptation rate can be adjusted based on other system behaviors and can be scaled based on number of commands executed before weights are adjusted.

Faster domains (for example, D0) process commands at a faster rate dependent on configured weight/bandwidth and slower domains (for example, D4) process commands at a slower rate. The rate for processing commands is independent of the submission rate of commands from the host. Each domain processes commands at a required rate irrespective of submission rate of commands from the host.

The bandwidth allocation and Quality of Service management in the solid-state drive 118 allows the host to precisely configure bandwidth and quality of service per domain by assigning host submission queues 202 to the domain. Virtual priority queues and scheduling avoids head of line blocking that can occur when multiple users concurrently access the same media (for example, a non-volatile memory die 200 in a solid-state drive 118). Credit based weighted fair queuing with adaptive weight allocation avoids the need to perform command over fetching to schedule commands in a system with many submission queues. Credit based weighted fair queuing with adaptive weight allocation limits the command fetch pool per domain reducing number of commands the command scheduler 500 has to schedule.

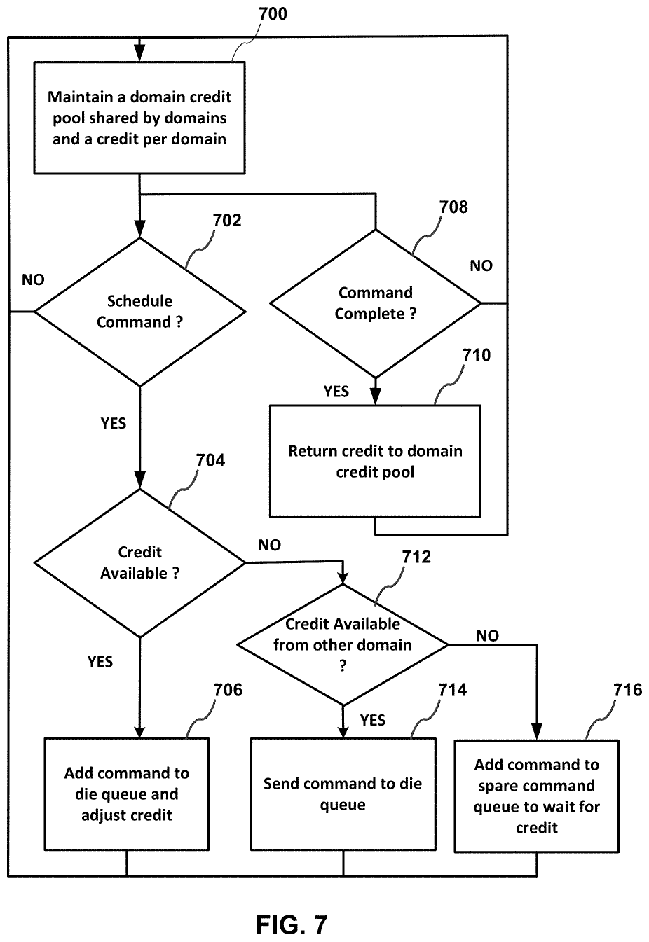

FIG. 7 is a flowgraph illustrating a method implemented in the solid-state drive 118 shared by a plurality of users shown in FIG. 1 to provide per user Bandwidth (BW) allocation and Quality of Service (QoS) using Adaptive Credit Based Weighted Fair Scheduling.

Host defined user bandwidth allocation is translated into base weights that allow the command scheduler 500 to prioritize commands. Credits are assigned in advance to each user domain. The base weights are adapted in real time as a function of quality of service requirements. Quality of service for each domain can be controlled independently as configured by the host.

At block 700, a domain credit pool 502 for all domains that share access to the solid-state drive and a credit per domain are maintained. In an embodiment the domain credit pool 502 and the credit per domain are maintained by the command scheduler 500 and per die scheduler 302.

At block 702, if there are commands in the host submission queues 202 for a non-volatile memory die 200 in the solid-state drive 118, processing continues with block 704.

At block 704, if credit is available for a domain to process the command, processing continues with block 706. If credit is not available, processing continues with block 712.

At block 706, the command is moved from the host submission queue 202 to the die queue 210 and credit is adjusted for the domain based on the Quality of Service requirement and commands already pending for the domain. After the commands is sent to the non-volatile memory die 200 from the command domain queue 212, credit balance for that domain is reduced. For each command, the credit is computed on the fly as discussed in conjunction with FIGS. 6A and 6B. If there are more commands pending in the die queue 210 for the domain, less credit is subtracted allowing that domain to execute more commands. Domains that require more bandwidth use lower per command credit subtraction thus allowing that particular domain to complete more commands. Processing continues with block 700 to maintain the domain credit pool 502.

At block 708, if a command has been sent to the non-volatile memory die 200 from the command domain queue 212, processing continues with block 710.

At block 710, when the non-volatile memory die 200 is ready to service the command for the domain (for example, the state of a Ready/Busy pin on a NAND device indicates that the current command has been completed and another command can be sent), command execution credit for the command completed by the non-volatile memory die 200 is returned to the domain credit pool 502. Processing continues with block 700 to maintain the domain credit pool 502.

At block 712, the bandwidth (credits) allocated to each domain is the minimum bandwidth to be provided to the domain. However, if bandwidth is available because the bandwidth allocated to another domain is not currently being used, additional bandwidth can be allocated to the domain. The command scheduler 500 can dynamically redistribute reserved bandwidth in the domain for a first user that is unused by the first user to a second user. If there is additional bandwidth (credits) available from another domain, processing continues with block 714. If not, processing continues with block 717.

At block 714, if a command for the domain is not available in host submission queues 202, a command is fetched from the per domain spare commands queue 204 is fetched. A command can be fetched from the per domain spare commands queue 204 while a command is being fetched for another domain. After the command is fetched, if another domain has provided credit to execute the command then this command is added to the respective die queue 210. Processing continues with block 700 to maintain the domain credit pool 502.

At block 716, the command is stored in a host submission queue 202 or spare commands queue 204 waiting for credit from the domain credit pool 502 in the command scheduler 500. If spare commands are not available in the spare commands queue 204, the command scheduler 500 is notified. The command scheduler 500 controls per domain command and resource usage count. If commands assigned to a particular domain are less than a minimum limit, the command scheduler 500 permits moving commands from host submission queues 202 to die queues 210 assigned to that domain. Processing continues with block 700 to maintain Credit Pool for all domains and credit per domain.

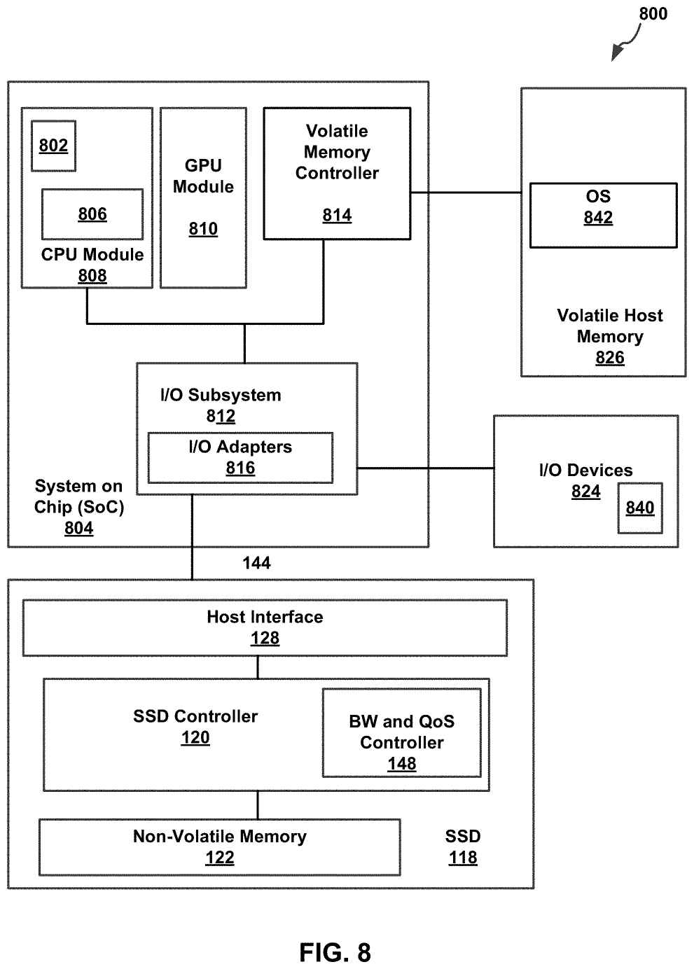

FIG. 8 is a block diagram of an embodiment of a computer system 800 that includes the bandwidth allocation and Quality of Service controller 148 in the storage device shared by multiple users. Computer system 800 can correspond to a computing device including, but not limited to, a server, a workstation computer, a desktop computer, a laptop computer, and/or a tablet computer.

The computer system 800 includes a system on chip (SOC or SoC) 804 which combines processor, graphics, memory, and Input/Output (I/O) control logic into one SoC package. The SoC 804 includes at least one Central Processing Unit (CPU) module 808, a volatile memory controller 814, and a Graphics Processor Unit (GPU) 810. In other embodiments, the volatile memory controller 814 can be external to the SoC 804. The CPU module 808 includes at least one processor core 802 and a level 2 (L2) cache 806.

Although not shown, each of the processor core(s) 802 can internally include one or more instruction/data caches, execution units, prefetch buffers, instruction queues, branch address calculation units, instruction decoders, floating point units, retirement units, etc. The CPU module 808 can correspond to a single core or a multi-core general purpose processor, such as those provided by Intel® Corporation, according to one embodiment.

The Graphics Processor Unit (GPU) 810 can include one or more GPU cores and a GPU cache which can store graphics related data for the GPU core. The GPU core can internally include one or more execution units and one or more instruction and data caches. Additionally, the Graphics Processor Unit (GPU) 810 can contain other graphics logic units that are not shown in FIG. 8, such as one or more vertex processing units, rasterization units, media processing units, and codecs.

Within the I/O subsystem 812, one or more I/O adapter(s) 816 are present to translate a host communication protocol utilized within the processor core(s) 802 to a protocol compatible with particular I/O devices. Some of the protocols that adapters can be utilized for translation include Peripheral Component Interconnect (PCI)-Express (PCIe); Universal Serial Bus (USB); Serial Advanced Technology Attachment (SATA) and Institute of Electrical and Electronics Engineers (IEEE) 1594 “Firewire”.

The I/O adapter(s) 816 can communicate with external I/O devices 824 which can include, for example, user interface device(s) including a display and/or a touch-screen display 840, printer, keypad, keyboard, communication logic, wired and/or wireless, storage device(s) including hard disk drives (“HDD”), solid-state drives (“SSD”), removable storage media, Digital Video Disk (DVD) drive, Compact Disk (CD) drive, Redundant Array of Independent Disks (RAID), tape drive or other storage device. The display 840 communicatively coupled to the processor core 802 to display data stored in the non-volatile memory dies 200 in the solid-state drive 118. The storage devices can be communicatively and/or physically coupled together through one or more buses using one or more of a variety of protocols including, but not limited to, SAS (Serial Attached SCSI (Small Computer System Interface)), PCIe (Peripheral Component Interconnect Express), NVMe (NVM Express) over PCIe (Peripheral Component Interconnect Express), and SATA (Serial ATA (Advanced Technology Attachment)).

Additionally, there can be one or more wireless protocol I/O adapters. Examples of wireless protocols, among others, are used in personal area networks, such as IEEE 802.15 and Bluetooth, 4.0; wireless local area networks, such as IEEE 802.11-based wireless protocols; and cellular protocols.

The I/O adapter(s) 816 can also communicate with the solid-state drive (“SSD”) 118 that includes the bandwidth allocation and quality of service controller 148 discussed in conjunction with FIGS. 1-7.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”)), or 3D NAND. A NVM device can also include a byte-addressable write-in-place three dimensional crosspoint memory device, or other byte addressable write-in-place NVM devices (also referred to as persistent memory), such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

The I/O adapters 816 can include a Peripheral Component Interconnect Express (PCIe) adapter that is communicatively coupled using the NVMe (NVM Express) over PCIe (Peripheral Component Interconnect Express) protocol over bus 144 to a host interface 128 in the solid-state drive 118. Non-Volatile Memory Express (NVMe) standards define a register level interface for host software to communicate with a non-volatile memory subsystem (for example, a Solid-State Drive (SSD)) over Peripheral Component Interconnect Express (PCIe), a high-speed serial computer expansion bus). The NVM Express standards are available at www.nvmexpress.org. The PCIe standards are available at www.pcisig.com.

Volatile memory is memory whose state (and therefore the data stored in it) is indeterminate if power is interrupted to the device. Dynamic volatile memory requires refreshing the data stored in the device to maintain state. One example of dynamic volatile memory includes DRAM (Dynamic Random Access Memory), or some variant such as Synchronous DRAM (SDRAM). A memory subsystem as described herein can be compatible with a number of memory technologies, such as DDR3 (Double Data Rate version 3, original release by JEDEC (Joint Electronic Device Engineering Council) on Jun. 27, 2007). DDR4 (DDR version 4, initial specification published in September 2012 by JEDEC), DDR4E (DDR version 4), LPDDR3 (Low Power DDR version3, JESD209-3B, August 2013 by JEDEC), LPDDR4) LPDDR version 4, JESD209-4, originally published by JEDEC in August 2014), WIO2 (Wide Input/Output version 2, JESD229-2 originally published by JEDEC in August 2014, HBM (High Bandwidth Memory, JESD325, originally published by JEDEC in October 2013, DDR5 (DDR version 5, currently in discussion by JEDEC), LPDDR5 (currently in discussion by JEDEC), HBM2 (HBM version 2), currently in discussion by JEDEC, or others or combinations of memory technologies, and technologies based on derivatives or extensions of such specifications. The JEDEC standards are available at wwwjedec.org.

An operating system 742 is software that manages computer hardware and software including memory allocation and access to I/O devices. Examples of operating systems include Microsoft® Windows®, Linux®, iOS® and Android®.

Flow diagrams as illustrated herein provide examples of sequences of various process actions. The flow diagrams can indicate operations to be executed by a software or firmware routine, as well as physical operations. In one embodiment, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood as an example, and the process can be performed in a different order, and some actions can be performed in parallel. Additionally, one or more actions can be omitted in various embodiments; thus, not all actions are required in every embodiment. Other process flows are possible.

To the extent various operations or functions are described herein, they can be described or defined as software code, instructions, configuration, and/or data. The content can be directly executable (“object” or “executable” form), source code, or difference code (“delta” or “patch” code). The software content of the embodiments described herein can be provided via an article of manufacture with the content stored thereon, or via a method of operating a communication interface to send data via the communication interface. A machine readable storage medium can cause a machine to perform the functions or operations described, and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

Besides what is described herein, various modifications can be made to the disclosed embodiments and implementations of the invention without departing from their scope.

Therefore, the illustrations and examples herein should be construed in an illustrative, and not a restrictive sense. The scope of the invention should be measured solely by reference to the claims that follow.

What is claimed is:

1. A solid-state drive comprising:
a plurality of non-volatile memory dies;
a plurality of die queues and a plurality of command domain queues to store a command for one of the plurality of non-volatile memory dies, each of the plurality of die queues to store commands for which resources have been allocated for one of a plurality of command types for one of a plurality of users of the solid-state drive and each of the plurality of command domain queues to store commands with one of a plurality of command types for the plurality of users of the solid-state drive for which resources have been allocated; and
a command scheduler, the command scheduler to dynamically assign a command received from a host communicatively coupled to the solid-state drive stored in a host submission queue in the solid-state drive to the plurality of die queues and the plurality of command domain queues to ensure a weighted fair share of bandwidth amongst the plurality of users of the solid-state drive.

2. The solid-state drive of claim 1, wherein the command scheduler to use late resource binding to assign resources to commands that are ready to be scheduled to avoid resource deadlock.

3. The solid-state drive of claim 2, wherein the command scheduler to synchronize fetch of a command from the host submission queue based on a credit mechanism to avoid over fetching.

4. The solid-state drive of claim 1, wherein the command scheduler to dynamically redistribute reserved bandwidth within a group of users for a first user that is unused by the first user to a second user.

5. The solid-state drive of claim 1, further comprising:
a plurality of spare commands queues, each of the plurality of spare commands queues to store a command for which resources have not be allocated to be assigned to one of the plurality of die queues.

6. The solid-state drive of claim 1, wherein a maximum number of entries in each of the plurality of command domain queues is 2, a maximum number of entries in each of the plurality of die queues is 32 and a number of non-volatile memory dies is 256.

7. The solid-state drive of claim 1, wherein the non-volatile memory is Quad-Level Cell (QLC) NAND or 3D NAND.

8. A method comprising:
a plurality of non-volatile memory dies;
storing a command in one of a plurality of die queues for which resources have been allocated for one of a plurality of command types for one of a plurality of users for one of a plurality of non-volatile memory dies in a solid-state drive;
storing commands with one of the plurality of command types for the plurality of users of the solid-state drive for which resources have been allocated in one of a plurality of command domain queues; and
dynamically assigning, by a command scheduler, a command received from a host communicatively coupled to the solid-state drive stored in a host submission queue in the solid-state drive to the plurality of die queues to ensure a weighted fair share of bandwidth amongst the plurality of users of the solid-state drive.

9. The method of claim 8, further comprising:
using late resource binding, by the command scheduler, to assign resources to commands that are ready to be scheduled to avoid resource deadlock.

10. The method of claim 9, further comprising:
synchronizing, by the command scheduler, a fetch of a command from the host submission queue based on a credit mechanism to avoid over fetching.

11. The method of claim 8, wherein the command scheduler to dynamically redistribute reserved bandwidth within a group of users for a first user that is unused by the first user to a second user.

12. The method of claim 8, further comprising:
storing, in a plurality of spare commands queues, commands for which resources have not be allocated to be assigned to one of the plurality of die queues in a plurality of spare commands queues.

13. The method of claim 8, wherein the non-volatile memory is Quad-Level Cell (QLC) NAND or 3D NAND.

14. The method of claim 8, wherein a maximum number of entries in each of the plurality of command domain queues is 2, a maximum number of entries in each of the plurality of die queues is 32 and a number of non-volatile memory dies is 256.

15. A system comprising:
a plurality of non-volatile memory dies;
a plurality of die queues and a plurality of command domain queues to store a command for one of the plurality of non-volatile memory dies, each of the plurality of die queues to store commands for which resources have been allocated for one of a plurality of command types for one of a plurality of users of a solid-state drive and each of the plurality of command domain queues to store commands with one of a plurality of command types for the plurality of users of the solid-state drive for which resources have been allocated; and
a command scheduler, the command scheduler to dynamically assign a command received from a host communicatively coupled to the solid-state drive stored in a host submission queue in the solid-state drive to the plurality of die queues and the plurality of command domain queues to ensure a weighted fair share of bandwidth amongst the plurality of users of the solid-state drive; and
a display communicatively coupled to a processor to display data stored in the non-volatile memory dies in the solid-state drive.

16. The system of claim 15, wherein the command scheduler to use late resource binding to assign resources to commands that are ready to be scheduled to avoid resource deadlock.

17. The system of claim 16, wherein the command scheduler to synchronize fetch of a command from the host submission queue based on a credit mechanism to avoid over fetching.

18. The system of claim 15, wherein the command scheduler to dynamically redistribute reserved bandwidth within a group of users for a first user that is unused by the first user to a second user.

19. The system of claim 15, further comprising:
a plurality of spare commands queues, each of the plurality of spare commands queues to store a command for which resources have not be allocated to be assigned to one of the plurality of die queues.

20. The system of claim 15, wherein a maximum number of entries in each of the plurality of the command domain queues is 2, a maximum number of entries in each of the plurality of die queues is 32 and a number of non-volatile memory dies is 256.
